(19) United States
(12) Patent Application Publication
(10) Pub. No.: US 2009/0285421 A1
(43) Pub. Date: Nov. 19, 2009

(54) RADIO HEADSET DEVICE FOR HIGH NOISE ENVIRONMENT

(76) Inventors: Eric GREENE, Sahuarita, AZ (US); Richard GREENE, Sahuarita, AZ (US)

Correspondence Address: BERENATO, WHITE & STAVISH, LLC, 6550 ROCK SPRING DRIVE, SUITE 240, BETHESDA, MD, 20817, US

(21) Appl. No.: 12/468,244

(22) Filed: May 19, 2009

Related U.S. Application Data
(60) Provisional application No. 61/071,808, filed on May 19, 2008.

(51) Int. Cl. H04R 5/02; G10K 11/16

(52) U.S. Cl. 381/309; 381/71.6

(57) ABSTRACT

A radio headset device provided for receiving and reproducing a radio broadcast from a radio device in a high noise environment. The radio headset device comprises left and right earcups, a speaker mounted to each of the earcups, and a microphone mounted to each of the earcups for converting acoustic noise outside the earcup into a corresponding electric noise signal. The radio headset device further comprises a noise cancellation module electrically connected to the microphones and the speakers, and a radio connector provided on one of the left and right earcups for selectively electrically connecting the radio headset device to a radio device. The noise cancellation module receives the electric noise signal from the microphones and generates a noise cancellation signal acoustically reproduced by the speakers.

### CROSS-REFERENCE TO RELATED APPLICATION

This Application claims the benefit under 35 U.S.C. 119(e) of U.S. Provisional Application Ser. No. 61/071,808 filed May 19, 2008 by Eric Greene and Richard Greene, which is hereby incorporated herein by reference in its entirety.

### BACKGROUND OF THE INVENTION

1. Field of the Invention

The present inventions relates to headsets in general and more particularly to a radio headset with an auxiliary input and noise cancellation.

2. Description of the Prior Art

Radio headset systems are commonly known as radio headsets or radio headset devices. They allow listening to radio, such as a satellite radio or a scanner radio, so that hands of a user are free for other activities. However, in a high noise environment, such as a live motorsports event, it can become impossible to hear the radio broadcast, such as a pit crew conversation, if there is no shielding of the user from the noise.

Automobile racing is a popular spectator sport and persons attending such racing events often desire to be closer to participants in the racing event, rather than merely observers of the race. The spectators who attend racing events, such as NASCAR, often identify with particular drivers and wish to know as much as possible about what is happening with regard to their favorite driver during the race. Race cars are frequently equipped with two-way radios so that the drivers can communicate with their pit crews and managers so that the driver can be informed of what is happening on the race track and the driver can inform the members of the pit crew concerning the race and condition of the car. Spectators can monitor these communications and gain a more intimate contact with the race and thus enhance the enjoyment of the racing event. Such spectator interest also applies to other types of events such as golf, baseball, basketball, etc.

Portable handheld scanning radios have been available which can be utilized for monitoring these communications. An example of such a radio designed for sporting events is the Uniden Model SC200. The systems described herein are radio receivers with capabilities that further enhance the spectators' experience at a sporting event or other venues which have both audio, such as voice, and data. However, these prior devices fail to provide the enhanced event experience desired by typical spectators.

With this in mind, a need exists to develop a versatile radio headset device with noise cancellation that advances the art.

### SUMMARY OF THE INVENTION

The present invention provides an improved radio headset device for receiving and reproducing a radio broadcast from a radio device in a high noise environment. The radio headset device in accordance with the present invention comprises left and right earcups, a speaker mounted to each of the earcups, and a microphone mounted to each of the earcups for converting acoustic noise outside the earcup into a corresponding electric noise signal. The radio headset device further comprises a noise cancellation module electrically connected to the microphones and the speakers, and a radio connector provided on one of the left and night earcups for selectively electrically connecting the radio headset device to a radio device. The noise cancellation module receives the electric noise signal from the microphones and generates a noise cancellation signal acoustically reproduced by the speakers.

### BRIEF DESCRIPTION OF THE DRAWINGS

Other objects and advantages of the invention will become apparent from a study of the following specification when viewed in light of the accompanying drawings, wherein:

FIG. 1 is a front view of a radio headset device according to a preferred embodiment of the present invention;

FIG. 2 is an exploded perspective view of a left ear cup of the radio headset device according to the preferred embodiment of the present invention;

FIG. 3 is an exploded perspective view of a right ear cup of the radio headset device according to the preferred embodiment of the present invention;

FIG. 4 is a schematic diagram of the electronics and wiring incorporated in the radio headset device according to the preferred embodiment of the present invention.

### DESCRIPTION OF PREFERRED EMBODIMENTS

The preferred embodiment of the present invention will now be described with the reference to accompanying drawing. It will be understood by those of skill in the art that the following embodiment is presented as a preferred example envisioned by the inventors, but that various changes may be made without departing from the spirit and scope of the invention. For example, this invention has been described with reference to a NASCAR or other race environment; however, the invention may be suitable for other event being broadcast as described herein.

For purposes of the following description, certain terminology is used in the following description for convenience only and is not limiting. The words such as “front” and “rear”, “left” and “right”, “top” and “bottom”, “inwardly” and “outwardly” designate directions in the drawings to which reference is made. The words “smaller” and “larger” refer to relative size of elements of the apparatus of the present invention and designated portions thereof. The terminology includes the words specifically mentioned above, derivatives thereof and words of similar import. Additionally, the word “a”, as used in the claims, means “at least one”.

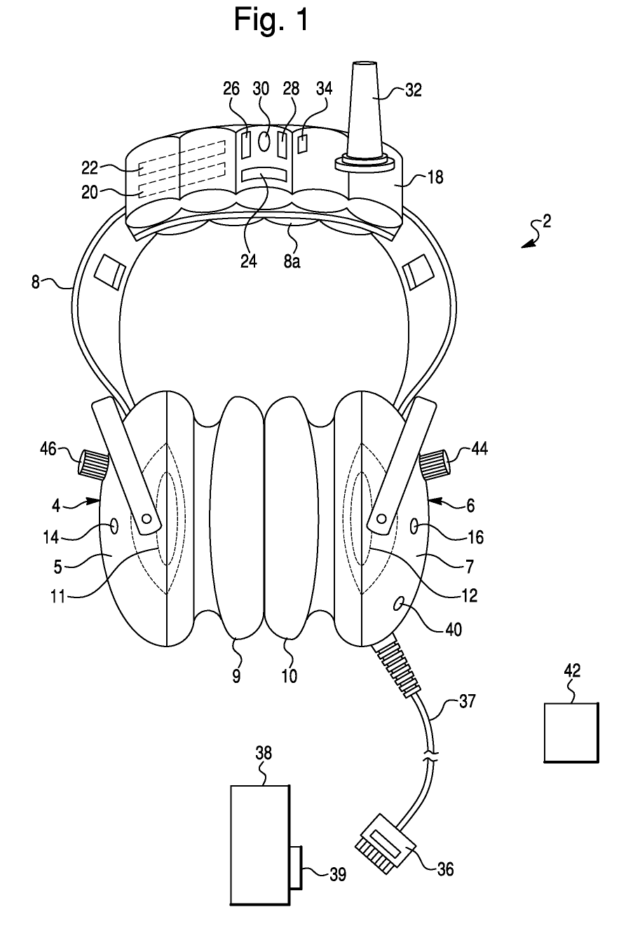

FIG. 1 of the drawings illustrates a radio headset device according to a preferred embodiment of the present invention, generally denoted by reference numeral 2. The radio headset device 2 comprises left and right earcups 4 and 6, respectively, connected by a headband 8. Each of the left and right earcups 4 and 6 carries a conventional annular cushion 9 and 10, respectively. The cushioned earcups 4, 6 fit snugly over ears of a user to aid in noise reduction. A cushion 8a on an inside portion of the headband 3 provides a comfortable fit on a top of a head of the user.

As further illustrated in FIG. 1, each of the left and right earcups 4 and 6 includes a hollow casing (5 and 7, respectively) formed of rigid plastic or other suitable material. The casings 5 and 7 house conventional speakers 11 and 12, respectively. Moreover, the left and right earcups 4 and 6 are provided with noise cancellation microphones 14 and 16, respectively, facing away from the casings 5, 7 and the speakers 11, 12. The noise cancellation microphones 14 and 16 are provided to convert acoustic noise outside the earcups 4, 6 (outside noise) into corresponding electric (preferably digital) noise signals.

A top portion 18 of the headband 8 houses various electrical components of the headset device 2. Specifically, a noise cancelation (or reduction) module 20, an audio boost amplifier 22 and a 9 volt battery (a power supply) 24 supplying a power for the audio boost amplifier 22 and the noise cancelation module 20 are concealed in the top portion 18 of the headband 8. Moreover, a power switch 26 and an Off/On switch 28 for audio boost (or an audio boost switch) are recessed into the top portion 18 of the headband 8. In other words, the audio boost switch 28 activates the audio boost amplifier 22. When the power switch 26 is switched on, a red LED 30 indicates the power is on. A high gain satellite radio antenna 32 and a preamplifier 34 are located on the right side of the top portion 18 of the headband 8. It will be appreciated that the noise cancelation module 20, the audio boost amplifier 22, the satellite radio antenna 32 and the preamplifier 34 are conventional and well known in the art separate and apart from their combination as part of this invention.

Moreover, the right earcup 6 is provided with a radio connector, such as a male connector plug 36, for plugging into a complementary female plug 39 of a portable satellite radio device (satellite radio receiver) 38 that provides the left and right audio signals from the satellite radio device 38 and the antenna feed from the satellite radio antenna 32 of the headset device 2 to the satellite radio 38. In other words, the radio connector 36 is provided on one of the left and right earcups 4, 6 for selectively electrically connecting the radio headset device 2 to the radio device 38. The connector plug 36 is electrically connected to the right earcup 6 by an electrical cord 37 leading to the noise cancellation module 20 and the audio boost amplifier 22.

As further illustrated in FIGS. 1 and 3, the right earcup 6 is further provided with an auxiliary 3.5 mm input audio connector 40 is located near the bottom of the right ear cup 6 for electrical connection to an auxiliary audio source 42 (shown in FIG. 1), such as a scanner radio device (scanner radio receiver). Such an arrangement of the radio headset device 2 allows a user, for example, to listen to pit crew conversations with a driver on a race car during a high noise environment of a live motorsports event. Incorporated in the radio headset device 2 is the ability to mix two audio sources, (i.e., the satellite radio device 38 and the scanner radio device), selectively adjust the audio level and, if required, boost the audio level with the audio boost amplifier 22. The ratio of the mixture is preferably controlled by the user directly on the headset device 2.

The audio boost amplifier 22 is, preferably, a fixed gain stereo amplifier that can be activated by the audio boost switch 28 to boost the audio level of the signal from the portable satellite radio device 38 and/or the scanner radio device before it arrives at the left and right ear cup speakers 11, 12.

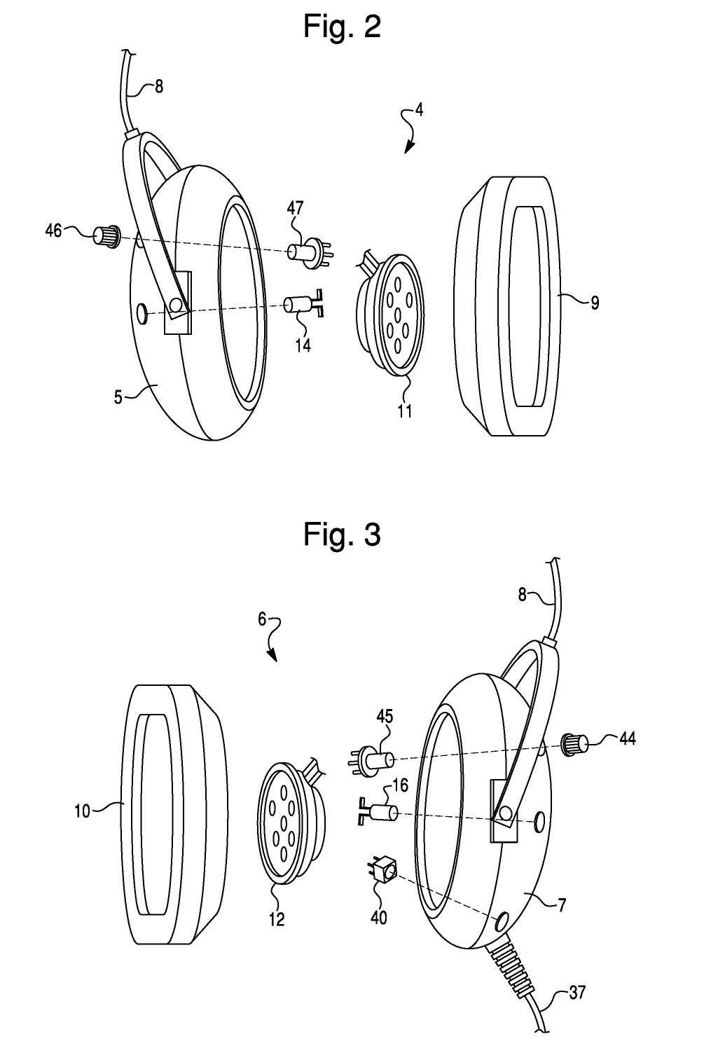

As further illustrated in FIGS. 1, 3 and 4, the radio headset device 2 comprises a volume control knob 44 located on the outside of the right earcup 6 operating a corresponding volume potentiometer 45 disposed in the casing 7 of the right earcup 6 (defining a volume control). Similarly, as illustrated in FIGS. 1, 2 and 4, the radio headset device 2 comprises a balance/mix control knob 46 located on the outside of the left earcup 4 operating a corresponding balance/mix potentiometer 47 disposed in the casing 5 of the left earcup 4 (defining a balance control). It will be appreciated that the balance control 46, 47 provide the radio headset device 2 with the ability to mix signals from two audio sources: the portable satellite radio device 38 (through the connector plug 36) and the scanner radio device (through the auxiliary audio input 40), together.

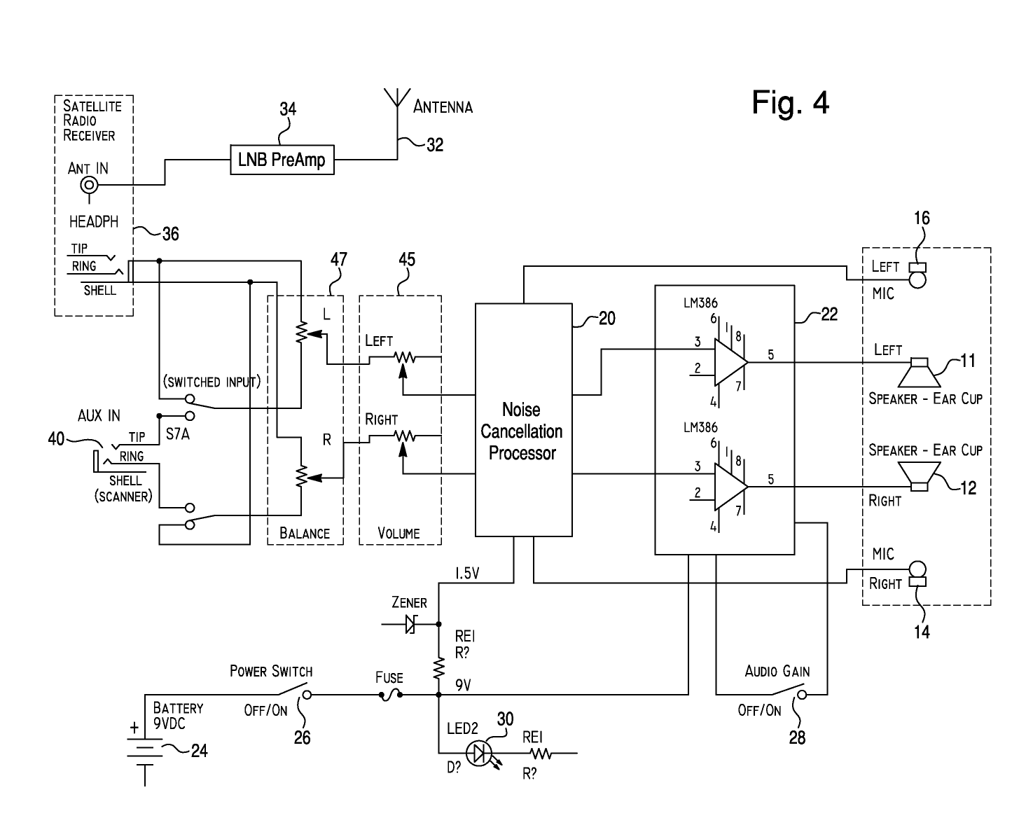

The wiring diagram, illustrated in FIG. 4, shows the signal flow from the radio headphone connector 36 and the auxiliary audio connector 40 to the balance/mix potentiometer 47. The signal path continues to the volume potentiometer 45 and through the noise cancelation module 20 to the audio boost amplifier 22. The final step is to feed the processed audio signal to the speakers 9 and 10 in the headset ear cups 4 and 6.

Included on the wiring diagram of FIG. 4 are the satellite antenna 32, the preamplifier 34, and the 9 vdc battery power supply 24. It will be appreciated that the power supply 24 can be a rechargeable battery. The battery 24 provides power supply for the noise cancellation module 20 and the audio boost amplifier 22. The high gain satellite antenna 32 mounted to the top 18 of the headset band 8 provides the required signal for the portable satellite radio 38. The 3.5 mm connector 40 in the right earcup 6 allows for the electrical connection of the auxiliary audio source, such as the scanner radio to listen to the pit crew conversations with the driver on the race car. Therefore, incorporated in the radio headset device 2 is the ability to mix two audio sources, adjust the audio level and, if required, boost the audio level with the audio boost amplifier 22.

To aid in clarity of the audio signal, the active noise cancelation module 20 is incorporated into the radio headset device 2 after the volume control 44, 45. The noise reduction module 20 uses the two small microphones 14 and 16 mounted on each side of the radio headset device 2. The microphones 14 and 16 sample the ambient sound (noise), invert the sampled sound signal and mix the inverted signal with the desired audio signal from the portable satellite radio 38 and/or the auxiliary audio source, such as the scanner radio. The inverted signal cancels the unwanted sound in the speakers 11 and 12 of the ear cups 4 and 6. In other words, the microphones 14 and 16 mounted to each of said earcups 4 and 6 convert acoustic noise outside the earcups 4 and 6 into a corresponding electric noise signal, while the noise cancellation module 20 receives the electric noise signal from the microphones 14 and 16 and generates a noise cancellation signal acoustically reproduced by the speakers 11 and 12. If additional audio volume is required, a fixed gain stereo amplifier can be activated to boost the signal before it arrives at the left and right ear cup speakers.

The foregoing description of the preferred embodiment of the present invention has been presented for the purpose of illustration in accordance with the provisions of the Patent Statutes. It is not intended to be exhaustive or to limit the invention to the precise forms disclosed. Obvious modifications or variations are possible in light of the above teachings. The embodiment disclosed hereinabove was chosen in order to best illustrate the principles of the present invention and its practical application to thereby enable those of ordinary skill in the art to best utilize the invention in various embodiments and with various modifications as are suited to the particular use contemplated, as long as the principles described herein are followed. Thus, changes can be made in the above-described invention without departing from the intent and scope thereof. It is also intended that the scope of the present invention be defined by the claims appended thereto.

What is claimed is:

1. A radio headset device comprising:
left and right earcups;
a speaker mounted to each of said earcups;
a microphone mounted to each of said earcups for converting acoustic noise outside said earcup into a corresponding electric noise signal;
a noise cancellation module electrically connected to said microphones and said speakers, said noise cancellation module receiving said electric noise signal from said microphones and generating a noise cancellation signal acoustically reproduced by said speakers; and
a radio connector provided on one of said left and right earcups for selectively electrically connecting said radio headset device to a radio device.

2. The radio headset device as defined in claim 1, further comprising a headband connecting said left and right earcups to each other.

3. The radio headset device as defined in claim 2, wherein said noise cancelation module, is provided in a top portion of said headband.

4. The radio headset device as defined in claim 1, further comprising an antenna operatively electrically connected to said radio connector for providing a radio signal for the radio.

5. The radio headset device as defined in claim 4, further comprising a preamplifier operatively electrically connected to said antenna to enhance said radio signal.

6. The radio headset device as defined in claim 1, further comprising an audio boost amplifier operatively electrically connected to said speakers to boost an audio signal.

7. The radio headset device as defined in claim 6, further comprising an audio boost switch provided to activate said audio boost amplifier.

8. The radio headset device as defined in claim 1, further comprising a battery providing power for said noise cancellation module, said microphones and said speakers.

9. The radio headset device as defined in claim 8, further comprising a power switch provided to electrically connect said battery to said noise cancellation module, said microphones and said speakers.

10. The radio headset device as defined in claim 1, further comprising an auxiliary input connector provided on one of said left and right earcups for selectively electrically connecting said radio headset device to an auxiliary audio source.

11. The radio headset device as defined in claim 10, wherein said auxiliary audio source is a scanner radio device.

12. The radio headset device as defined in claim 10, further comprising a balance/mix potentiometer disposed in one of said left and right earcups and a corresponding balance/mix control knob located on the outside of said one of said left and right earcups for operating said balance/mix potentiometer; said balance/mix potentiometer provided for mixing signals from said radio device and said auxiliary audio source together.

13. The radio headset device as defined in claim 1, further comprising an antenna operatively electrically connected to said radio connector for providing a radio signal for the radio and a preamplifier operatively electrically connected to said antenna to enhance said radio signal.

14. The radio headset device as defined in claim 13, further comprising an audio boost amplifier operatively electrically connected to said speakers to boost an audio signal and an audio boost switch provided to activate said audio boost amplifier.

15. The radio headset device as defined in claim 14, further comprising a battery providing power for said noise cancellation module, said audio boost amplifier, said microphones and said speakers.

16. The radio headset device as defined in claim 15, further comprising an auxiliary input connector provided on one of said left and right earcups for selectively electrically connecting said radio headset device to an auxiliary audio source.

17. The radio headset device as defined in claim 16, further comprising a balance/mix potentiometer disposed in one of said left and right earcups and a corresponding balance/mix control knob located on the outside of said one of said left and right earcups for operating said balance/mix potentiometer; said balance/mix potentiometer provided for mixing signals from said radio device and said auxiliary audio source together.

18. The radio headset device as defined in claim 17, further comprising a headband connecting said left and right earcups to each other.

19. The radio headset device as defined in claim 18, wherein said noise cancelation module, said audio boost amplifier, said preamplifier, said audio boost switch and said battery are provided in a top portion of said headband.

20. A radio headset device comprising:
a pair of speakers for placement on a user's head;
a microphone mounted to each of said pair of speakers for converting acoustic noise outside said speakers into a corresponding electric noise signal;
a noise cancellation module electrically connected to said microphone and said speakers, said noise cancellation module receiving said electric noise signal from said microphone and generating a noise cancellation signal acoustically reproduced by said speakers;
a radio connector electrically connected to said pair of speakers for selectively electrically connecting said radio headset device to a radio device;
an auxiliary input connector electrically connected to said pair of speakers for selectively electrically connecting said radio headset device to an auxiliary audio source in the form of a scanner radio device; and
a balance/mix potentiometer electrically connected to said pair of speakers for operating said balance/mix potentiometer; said balance/mix potentiometer provided for mixing signals from said radio device and said auxiliary audio source together.
